(19) United States
(12) Patent Application Publication
(10) Pub. No.: US 2014/0002804 A1
(43) Pub. Date: Jan. 2, 2014

(54) Laser Scanning Projection System with Reduced Speckle Contrast and Speckle Contrast Reducing Method

(71) Applicants: Fu-Ji Tsai, Hsinchu (TW); Wei-Chih Lin, Hsinchu (TW); Wen-Lung Lin, Hsinchu (TW)

(72) Inventors: Fu-Ji Tsai, Hsinchu (TW); Wei-Chih Lin, Hsinchu (TW); Wen-Lung Lin, Hsinchu (TW)

(73) Assignee: LITE-ON IT CORPORATION, Taipei City (TW)

(21) Appl. No.: 13/535,727

(22) Filed: Jun. 28, 2012

(51) Int. Cl. G03B 21/28; G03B 21/14

(52) U.S. Cl. 353/98; 353/121

(57) ABSTRACT

A speckle contrast reducing method for a laser scanning projection system includes the following steps. Firstly, a laser beam is provided. The laser beam is projected on a projection surface according to a first scanning trajectory, thereby generating a first image frame. Sequentially, the laser beam is projected on the projection surface according to a second scanning trajectory, thereby generating a second image frame at an image refresh rate. Moreover, the second scanning trajectory of the second image frame is shifted by a displacement from the first scanning trajectory of the first image frame along a slow-axis direction.

### FIELD OF THE INVENTION

The present invention relates to a laser scanning projection system, and more particularly to a laser scanning projection system with reduced speckle contrast. The present invention relates to a speckle contrast reducing method for a laser scanning projection system.

### BACKGROUND OF THE INVENTION

As known, a laser source has a narrower emission spectrum than a LED source. The use of the laser source in a projection system is able to result in better color purity and create vivid images with extensive color coverage. However, due to the narrow spectrum and the coherent property of the laser source, speckle arises when the images are created. When a coherent beam from the laser source is projected onto a randomly-diffusing rough surface (e.g. a wall), a portion of the reflected beam may constructively or destructively interfere with another portion of the reflected beam. Consequently, the intensity of the reflected beam fluctuates. Moreover, the constructive interference and the destructive interference of the reflected beam may result in randomly distributed bright/dark fringes in the space. In the human vision system (e.g. pupil, lens, and retina) with a finite aperture, the randomly distributed bright/dark fringes in the space are imaged on the retina through a lens. That is, the visually laser speckle is generated.

FIG. 1 schematically illustrates the architecture of a conventional laser scanning projection system. As shown in FIG. 1, a laser source 101 emits a coherent beam 104 to an angular deflected device 103. By the angular deflected device 103, the coherent beam 104 is modulated into a modulated coherent beam 105. This modulated coherent beam 105 is projected onto a projection screen 107. Since the projection screen 107 has a randomly-diffusing rough surface, a portion of the reflected beam 108 may constructively or destructively interfere with another portion of the reflected beam 108. Under this circumstance, the image 106 viewed by the observer 102 appears to have speckle. Since the speckle is detrimental to the imaging quality, some imaging systems have been disclosed to reduce the speckle.

For example, an imaging system using an angular diversity mechanism to reduce a speckle contrast ratio is disclosed in US Patent Publication No. 20120013855 A1. The imaging system employs a light translation element to project a laser beam onto different locations of the projection surface along more than two optical paths. Consequently, the optical path of received light can be altered between multiple locations. In such way, the projection information of a single laser light spot may be switched between different locations to provide the angular diversity. However, it is very complicated to process the image. Moreover, for keeping the image stable, when the original single projection signal is shifted to a different location, the input signal at the corresponding location should be changed.

Furthermore, an imaging system using an angular diversity mechanism and a wavelength diversity mechanism is disclosed in US Patent Publication No. 20120013852 A1. A plurality of laser sources are classified into several laser source pair. Each laser source pair is configured to produce two beams of substantially the same color. By a light translation element, the two beams are projected onto the projection surface along two optical paths. Consequently, the optical path of received light can be altered between multiple locations. In such way, the RGB laser light spots with two different wavelengths are projected on different locations of the projection surface to provide the angular diversity and the wavelength diversity. However, the process of assembling this imaging system is complicated, and thus the fabricating cost is high. For keeping the image stable, when the original single projection signal is shifted to a different location, the input signal at the corresponding location should be changed. Since the architecture of this imaging system is too complicated, it is difficult to keep the image stable.

Furthermore, an imaging system using a phase front spreading mechanism is disclosed in US Patent Publication No. 2012/0149251 A1. By a 2D diffractive optical element (DOE) or a periodically repeating phase mask, a single laser beam is expanded to multiple laser beams to be projected onto the projection surface. However, the use of the diffractive optical element may largely reduce the optical efficiency. Moreover, since a single beam is expanded into divergent beams and a plurality of divergent and focusing optical elements are employed, it is difficult to reduce the beam size for the single pixel. Under this circumstance, the image quality is blurred.

Furthermore, in US Patent Publication No. US 2009/0034041 A1, a depolarizer is employed to depolarizing a single laser beam into two polarized beams with substantially orthogonal polarization states, wherein there is an included angle between the two polarized beams. In addition, the two polarized beams are projected onto different locations of the projection surface. However, after the two correlated polarized beams with the orthogonal polarization states are reflected by the ordinary reflective surface (e.g. a non-polarization-maintaining scattering surface), the two reflected beams have various polarization states. Since the two reflected beams may interfere with each other again, the performance of reducing the laser speckle is unsatisfactory.

Therefore, there is a need of providing a laser scanning projection system with reduced speckle contrast and a speckle contrast reducing method in order to eliminate the drawbacks encountered from the prior art.

### SUMMARY OF THE INVENTION

The present invention provides a laser scanning projection system with reduced speckle contrast. The laser scanning projection system is effective to reduce the speckle contrast according to a time-sequentially scrambling manner and the imaging principle of the human visual persistence. Moreover, the laser scanning projection system of the present invention has simplified architecture and improved imaging quality.

An embodiment of the present invention provides a speckle contrast reducing method for a laser scanning projection system. The speckle contrast reducing method includes the following steps. Firstly, a laser beam is provided. The laser beam is projected on a projection surface according to a first scanning trajectory, thereby generating a first image frame. Sequentially, the laser beam is projected on the projection surface according to a second scanning trajectory, thereby generating a second image frame at an image refresh rate. Moreover, the second scanning trajectory of the second image frame is shifted by a displacement from the first scanning trajectory of the first image frame along a slow-axis direction.

Another embodiment of the present invention provides a laser scanning projection system with reduced speckle contrast. The laser scanning projection system includes a projection surface, an illumination unit, a scanning mirror module, and a tilt angle adjustable element. The illumination unit is used for emitting a laser beam along an optical path. The scanning mirror module is used for projecting the laser beam on the projection surface according to a scanning trajectory, thereby sequentially generating a plurality of image frames at an image refresh rate. The tilt angle adjustable element is used for periodically tilting the scanning mirror module at a tilt angle

A further embodiment of the present invention provides a laser scanning projection system with reduced speckle contrast. The laser scanning projection system includes a projection surface, an illumination unit, a scanning mirror module, and a driver. The illumination unit is used for emitting a laser beam along an optical path. The scanning mirror module is used for projecting the laser beam on the projection surface according to a scanning trajectory, thereby sequentially generating a plurality of image frames at an image refresh rate. The driver is used for periodically generating a fast-axis driving signal corresponding to a fast-axis direction and a slow-axis driving signal corresponding to a slow-axis direction according to the image refresh rate. The driver provides a different phase differences between the slow-axis driving signal and the fast-axis driving signal in two successive image frames.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 schematically illustrates the architecture of a conventional laser scanning projection system without speckle reduction function;

FIG. 2 schematically illustrates the architecture of a laser scanning projection system with reduced speckle contrast according to a first embodiment of the present invention;

FIG. 3 schematically illustrates the moving trajectory of the image frame obtained by the laser scanning projection system according to the first embodiment of the present invention;

FIGS. 4A, 4B and 4C schematically illustrate three exemplary tilt angle adjustable elements used in the laser scanning projection system according to the first embodiment of the present invention;

FIG. 5 schematically illustrates the architecture of a laser scanning projection system with reduced speckle contrast according to a second embodiment of the present invention;

FIG. 6 schematically illustrates a first approach for reducing the speckle contrast by using the laser scanning projection system according to the second embodiment of the present invention; and

FIG. 7 schematically illustrates a second approach for reducing the speckle contrast by using the laser scanning projection system according to the second embodiment of the present invention.

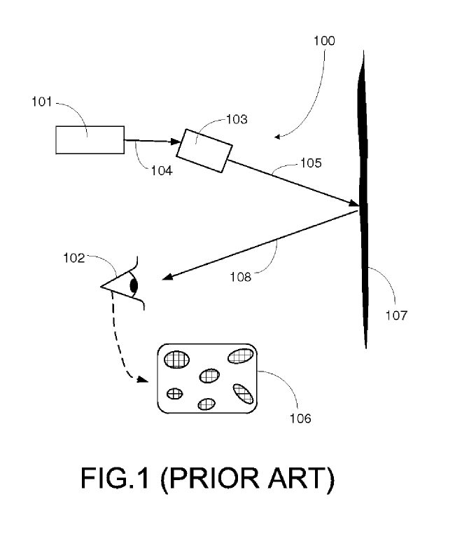

### DETAILED DESCRIPTION OF PREFERRED EMBODIMENTS

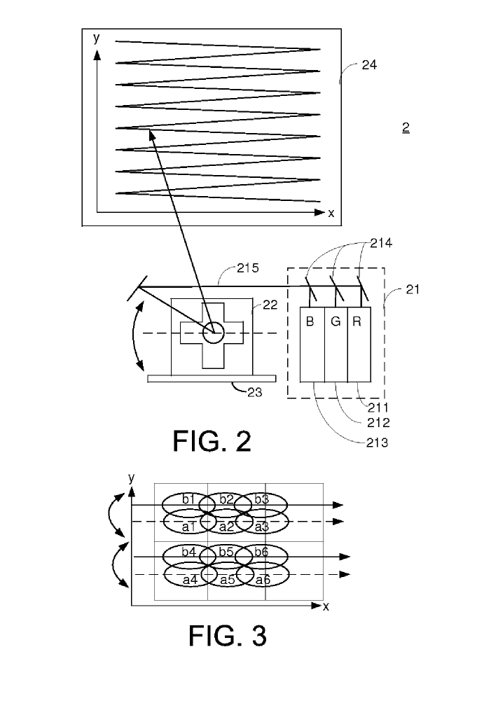

FIG. 2 schematically illustrates the architecture of a laser scanning projection system with reduced speckle contrast according to a first embodiment of the present invention. As shown in FIG. 2, the laser scanning projection system 2 comprises an illumination unit 21, a scanning mirror module 22, a tilt angle adjustable element 23, and a projection surface 24.

The illumination unit 21 comprises a plurality of laser sources 211, 212, 213 and one or more optical alignment elements 214. In this embodiment, the laser sources of the illumination unit 21 comprises a red laser source 211, a green laser source 212, and a blue laser source 213, as are respectively indicated by “R”, “G,” and “B” in FIG. 2. In this embodiment, the illumination unit 21 comprises three optical alignment elements 214. Examples of the optical alignment elements 214 include but are not limited to dichroic mirrors. By the optical alignment devices 214, the red beam, the green beam and the blue beam from the red laser source 211, the green laser source 212 and the blue laser source 213 are oriented into a single laser beam 215.

In this embodiment, the scanning mirror module 22 includes a two-dimensional micro scanning mirror such as a microelectromechanical (MEMS) scanning mirror. When the light beam 215 is reflected by the scanning mirror module 22, the light beam 215 is projected onto locations of the projection surface 24 in a raster scanning pattern or a Lissajous scanning pattern. Moreover, the laser beams with various wavelengths are time-sequentially projected onto the target locations in order to create a desired image. Take the raster scanning pattern for example. The projection laser beam 215 is swept across projection surface 24 and scans line-by-line from top to bottom. The raster scanning trajectory is shown in FIG. 2. Since the scanning frequency along the x-axis direction is munch higher than the scanning frequency along the y-axis direction, the x axis may be designated as a fast axis, and the y axis may be designated as a slow axis.

The laser scanning projection system 2 may further comprises a driver (not shown) for issuing a driving signal. According to the driving signal, the light beam 215 reflected from the scanning mirror module 22 is projected onto the projection surface 24 in a raster scanning pattern. The operating principles of the driver are known in the art, and are not redundantly described herein.

In accordance with a feature of the present invention, the scanning mirror module 22 is supported by the tilt angle adjustable element 23. According to the image frame rate, the tilt angle adjustable element 23 is periodically tilted at a small tilt angle. As the tilt angle adjustable element 23 is periodically tilted at a small tilt angle, the scanning mirror module 22 is slightly tilted, and the projection laser beam 215 is slightly deflected in the space. In such way, a scanning trajectory of a next image frame relative to the scanning trajectory of a current image frame is shifted by a displacement along the slow-axis direction. In an embodiment, the tilt angle of the tilt angle adjustable element 23 is smaller than 0.04 degree. Due to the small tilt angle, the laser beam 215 reflected by the scanning mirror module 22 is slightly deflected in the space, but the stability of the image is not impaired.

Moreover, the upper limit of the tilt angle may be determined according to the number of vertical scanning lines of the scanning mirror module 22. For example, if the number of vertical scanning lines is 720, the tilt angle of the tilt angle adjustable element 23 is smaller than 0.02 degree. Whereas, if the number of vertical scanning lines is 1080, the tilt angle of the tilt angle adjustable element 23 is smaller than 0.015 degree. Since the tilt angle of the tilt angle adjustable element 23 is smaller than the above upper limit, the displacement is smaller than a spacing interval between two adjacent vertical scanning lines. Under this circumstance, the problem of causing the blurred image is avoided, and the image uniformity is enhanced.

FIG. 3 schematically illustrates the scanning trajectory of the image frame obtained by the laser scanning projection system according to the first embodiment of the present invention. For clarification and brevity, the image frame composed of 3×2 pixels are illustrated herein. As shown in FIG. 3, six projection points a1, a2, a3, a4, a5 and a6 are sequentially generated to form a first image frame according to a first scanning trajectory, and six projection points b1, b2, b3, b4, b5 and b6 are sequentially generated to form a second image frame according to a second scanning trajectory. As the tilt angle adjustable element 23 is periodically tilted at a small tilt angle according to the image frame rate, the scanning mirror module 22 supported by the tilt angle adjustable element 23 is slightly tilted for ever-changing image frame.

As shown in FIG. 3, the dotted arrow shows the first moving trajectory of the first image frame, and the solid arrow shows the second moving trajectory of the second image frame. During the first image frame, the six projection points a1, a2, a3, a4, a5 and a6 are sequentially generated according to the first scanning trajectory. And, when entering the second image frame, the tilt angle adjustable element 23 is tilted at a small tilt angle that the six projection points b1, b2, b3, b4, b5 and b6 are sequentially generated according to the second scanning trajectory. The first scanning trajectory of the first image frame and the second scanning trajectory of the second image frame are shifted by a displacement along the slow-axis direction. From the above discussions, the fast-axis scanning line is sequentially and periodically shifted along the slow-axis direction, so that the perceived laser speckle pattern is time-sequentially changed. Moreover, due to the imaging principle of the human visual persistence, the contrast of the laser speckle for the human vision is reduced. In other words, the speckle contrast is reduced.

Please refer to FIG. 3 again. The scanning trajectories for two successive image frames are shifted by a displacement along the slow-axis direction. The displacement is smaller than a pixel pitch along the slow-axis direction. That is, the displacement is smaller than the spacing interval between two adjacent vertical scanning lines.

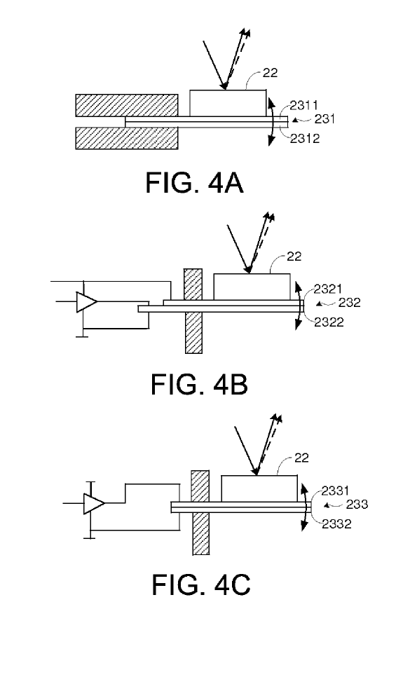

FIGS. 4A, 4B and 4C schematically illustrate three exemplary tilt angle adjustable elements used in the laser scanning projection system according to the first embodiment of the present invention. In the laser scanning projection system 2 of the present invention, the tilt angle adjustable element 23 is a bimorph actuator. As shown in FIG. 4A, the tilt angle adjustable element 231 is a combination of a piezoelectric ceramic element 2311 and a steel strip 2312. As shown in FIG. 4B, the tilt angle adjustable element 231 is a serial combination of two piezoelectric ceramic elements 2321 and 2322. As shown in FIG. 4C, the tilt angle adjustable element 231 is a parallel combination of two piezoelectric ceramic elements 2331 and 2332. When an electric field is applied to the bimorph actuator, the bimorph actuator is subject to deformation. The deformation amount is related to a small tilting angle and changed with time. The operating principles of these bimorph actuators are well known in the art, and are not redundantly described herein.

It is noted that the above descriptions of the first embodiment of this invention are presented herein for purpose of illustration and description only. Those skilled in the art will readily observe that numerous modifications and alterations may be made while retaining the teachings of the invention. For example, in some embodiments, the scanning mirror module 22 may include two one-dimensional micro scanning mirrors. For example, the micro scanning mirrors are both microelectromechanical (MEMS) scanning mirrors. In a case that the scanning mirror module 22 includes two micro scanning mirrors, one of the micro scanning mirrors has a faster scanning frequency along the x-axis direction, and the other micro scanning mirror has a slower scanning frequency along the y-axis direction.

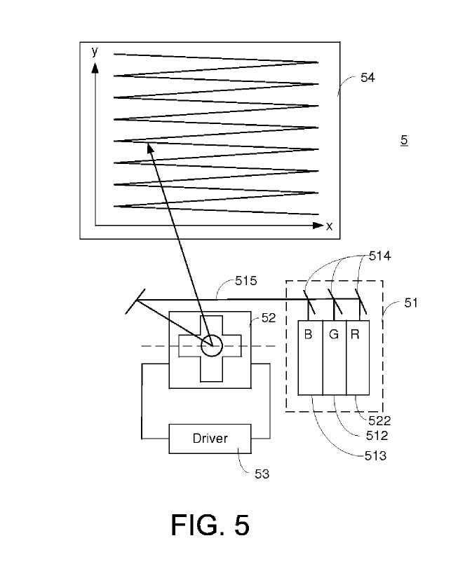

FIG. 5 schematically illustrates the architecture of a laser scanning projection system with reduced speckle contrast according to a second embodiment of the present invention. As shown in FIG. 5, the laser scanning projection system 5 comprises an illumination unit 51, a scanning mirror module 52, a driver 53, and a projection surface 54.

The illumination unit 51 comprises a plurality of laser sources 511, 512, 513 and one or more optical alignment elements 514. In this embodiment, the laser sources of the illumination unit 51 comprises a red laser source 511, a green laser source 512, and a blue laser source 513, as are respectively indicated by “R”, “G,” and “B” in FIG. 5. In this embodiment, the illumination unit 51 comprises three optical alignment elements 514. Examples of the optical alignment elements 514 include but are not limited to dichroic mirrors. By the optical alignment devices 514, the red beam, the green beam and the blue beam from the red laser source 511, the green laser source 512 and the blue laser source 513 are oriented into a single laser beam 515.

In this embodiment, the scanning mirror module 52 includes a two-dimensional micro scanning mirror such as a microelectromechanical (MEMS) scanning mirror. Alternatively, in some embodiments, the scanning mirror module 52 may include two one-dimensional micro scanning mirrors such as microelectromechanical (MEMS) scanning mirrors. Similarly, according to the scanning trajectory, since the scanning frequency along the x-axis direction is munch higher than the scanning frequency along the y-axis direction, the x axis may be designated as a fast axis, and the y axis may be designated as a slow axis.

In accordance with a key feature of the present invention, the driver 53 may issue a fast-axis driving signal and a slow-axis driving signal. According to the fast-axis driving signal, the scanning motion of the scanning mirror module 52 along the fast-axis direction is correspondingly controlled. According to the slow-axis driving signal, the scanning motion of the scanning mirror module 52 along the slow-axis direction is correspondingly controlled. The operating principles of the driver 53 are known in the art, and are not redundantly described herein.

There are two approaches for reducing the speckle contrast by using the laser scanning projection system according to the second embodiment of the present invention. In these two approaches, the driver 53 provides different phase differences between the slow-axis driving signal and the fast-axis driving signal in two successive image frames, therefore, the scanning trajectory is shifted in two successive image frames for reducing the speckle contrast.

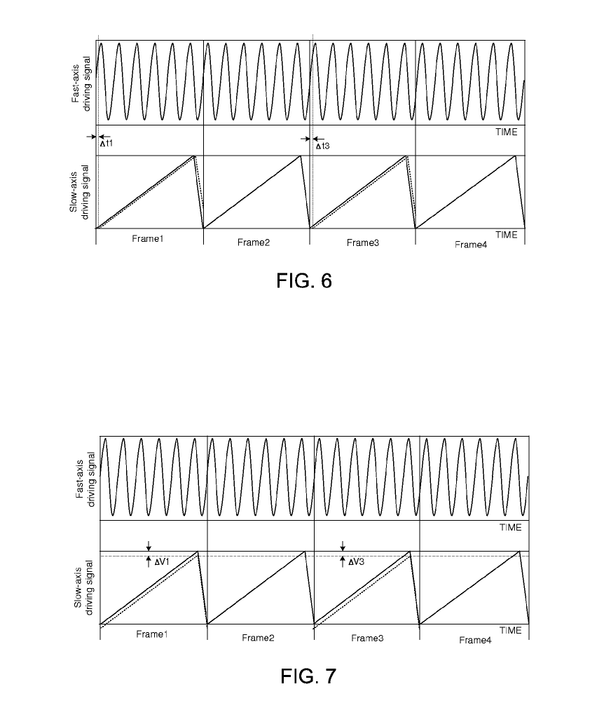

FIG. 6 schematically illustrates a first approach for reducing the speckle contrast by using the laser scanning projection system according to the second embodiment of the present invention. In FIG. 6, the waveforms of the fast-axis driving signal and the slow-axis driving signal outputted from the driver 53 are shown. In this embodiment, the phase difference between the slow-axis driving signal and the fast-axis driving signal is a time delay between the slow-axis driving signal and the fast-axis driving signal.

For clarification and brevity, four successive image frames that are time-sequentially generated are illustrated. For the first image frame, there is a time delay Δt1 between the slow-axis driving signal and the fast-axis driving signal. For the third image frame, there is a time delay Δt3 between the slow-axis driving signal and the fast-axis driving signal. The time delay Δt1 and the time delay Δt3 may be identical or different. For the second image frame and the four image frame, there is no phase difference between the slow-axis driving signal and the fast-axis driving signal.

In other words, the driver 53 provides different time delays between the slow-axis driving signal and the fast-axis driving signal in two successive image frames. By changing the time delay between the slow-axis driving signal and the fast-axis driving signal in two successive image frames, the scanning trajectory is changed and the projection laser beam 515 is slightly deflected in the space in two successive image frames. Similarly, in order to eliminate the problem of causing the blurred image, the displacement between two successive image frames should be smaller than the spacing interval between two adjacent vertical scanning lines. For achieving this purpose, if the scanning resolution of each image frame along the slow-axis direction is d lines and the image refresh rate is f, the time delay is smaller than 1/(d×f).

FIG. 7 schematically illustrates a second approach for reducing the speckle contrast by using the laser scanning projection system according to the second embodiment of the present invention. In FIG. 7, the waveforms of the fast-axis driving signal and the slow-axis driving signal outputted from the driver 53 are shown. In this embodiment, the phase difference between the slow-axis driving signal and the fast-axis driving signal is an amplitude offset between the slow-axis driving signal and the fast-axis driving signal.

For clarification and brevity, four successive image frames that are time-sequentially generated are illustrated. The slow-axis driving signal has an amplitude offset ΔV1 for the first image frame, and the slow-axis driving signal has an amplitude offset ΔV3 for the third image frame, wherein the amplitude offsets ΔV1 and ΔV3 may be identical or different. For the second image frame and the four image frame, there is no amplitude offset between the slow-axis driving signal and the fast-axis driving signal.

In other words, the driver 53 provides different amplitude offsets between the slow-axis driving signal and the fast-axis driving signal in two successive image frames. By changing the amplitude offset between the slow-axis driving signal and the fast-axis driving signal in two successive image frames, the scanning trajectory is changed and the projection laser beam 515 is slightly deflected in the space in two successive image frames. Similarly, in order to eliminate the problem of causing the blurred image, the displacement between two successive image frames should be smaller than the spacing interval between two adjacent vertical scanning lines. For achieving this purpose, if the scanning resolution of each image frame along the slow-axis direction is d lines and the amplitude of the slow-axis driving signal is V, the amplitude offset is smaller than V/d.

From the above description, the laser scanning projection system and the speckle contrast reducing method of the present invention are effective to reduce the speckle contrast according to a time-sequentially scrambling manner and the imaging principle of the human visual persistence. Moreover, the laser scanning projection system of the present invention has simplified architecture and improved imaging quality. The speckle contrast reducing method of the present invention of the present invention may be referred as a time-sequentially spatial decorrelation mechanism for effectively reducing the adverse influence of the visually laser speckle.

In the first embodiment, the laser scanning projection system comprises a tilt angle adjustable element in addition to the RGB laser sources and the MEMS scanning mirror, which are used in the conventional imaging system. Since the tilt angle adjustable element has small volume, the fabricating cost and the layout space of the imaging system are not obviously increased. In the second embodiment, the laser scanning projection system comprises the RGB laser sources and the MEMS scanning mirror, which are used in the conventional imaging system. By changing the phase difference between the slow-axis driving signal and the fast-axis driving signal in two successive image frames, the purpose of the speckle contrast reducing method is achievable. Moreover, in comparison with the conventional imaging system using multiple optical elements or the diffractive optical element, the laser scanning projection system of the present invention is simplified without deteriorating the overall efficiency.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A speckle contrast reducing method for a laser scanning projection system, the speckle contrast reducing method comprising steps of:
providing a laser beam;
projecting the laser beam on a projection surface according to a first scanning trajectory, thereby generating a first image frame; and
projecting the laser beam on the projection surface according a second scanning trajectory, thereby generating a second image frame at an image refresh rate, wherein the second scanning trajectory of the second image frame is shifted by a displacement from the first scanning trajectory of the first image frame along a slow-axis direction.

2. The speckle contrast reducing method as claimed in claim 1, wherein the displacement is smaller than a spacing interval between two adjacent vertical scanning lines along the slow-axis direction.

3. The speckle contrast reducing method as claimed in claim 1, wherein before the second image frame is generated, the speckle contrast reducing method further comprises a step of slightly deflecting the laser beam, so that the second scanning trajectory of the second image frame is shifted by the displacement from the first scanning trajectory of the first image frame along the slow-axis direction.

4. The speckle contrast reducing method as claimed in claim 3, wherein the step of slightly deflecting the laser beam is performed by tilting a scanning mirror module at a tilt angle, wherein the tilt angle is smaller than 0.04 degree.

5. The speckle contrast reducing method as claimed in claim 1, further comprising a step of periodically generating a fast-axis driving signal corresponding to a fast-axis direction and a slow-axis driving signal corresponding to the slow-axis direction, and providing a different phase differences between the slow-axis driving signal and the fast-axis driving signal in the first image frame and the second image frame.

6. The speckle contrast reducing method as claimed in claim 5, wherein the phase difference is obtained according to a time delay between the slow-axis driving signal and the fast-axis driving signal, wherein if a scanning resolution of each image frame along the slow-axis direction is d lines and the image refresh rate is f, the time delay is smaller than 1/(d×f).

7. The speckle contrast reducing method as claimed in claim 5, wherein the phase difference is obtained according to an amplitude offset between the slow-axis driving signal and the fast-axis driving signal, wherein if a scanning resolution of each image frame along the slow-axis direction is d lines and the slow-axis driving signal has an amplitude V, the amplitude offset is smaller than V/d.

8. The speckle contrast reducing method as claimed in claim 1, wherein the scanning trajectory is a raster scanning trajectory or a Lissajous scanning trajectory.

9. A laser scanning projection system with reduced speckle contrast, the laser scanning projection system comprising:
a projection surface;
an illumination unit for emitting a laser beam along an optical path;
a scanning mirror module for projecting the laser beam on the projection surface according to a scanning trajectory, thereby sequentially generating a plurality of image frames at an image refresh rate; and
a tilt angle adjustable element for periodically tilting the scanning mirror module at a tilt angle.

10. The laser scanning projection system as claimed in claim 9, wherein the illumination unit comprises a plurality of laser sources for emitting plural beams.

11. The laser scanning projection system as claimed in claim 10, wherein the illumination unit further comprises one or more optical alignment elements for orienting the plurality of beams from the plurality of laser sources into the laser beam.

12. The laser scanning projection system as claimed in claim 11, wherein the optical alignment elements are dichroic mirrors.

13. The laser scanning projection system as claimed in claim 9, wherein the scanning mirror module comprises a two-dimensional MEMS scanning mirror or two one-dimensional MEMS scanning mirrors.

14. The laser scanning projection system as claimed in claim 9, wherein the tilt angle adjustable element is a bimorph actuator.

15. The laser scanning projection system as claimed in claim 14, wherein the tilt angle adjustable element is a combination of a piezoelectric ceramic element and a steel strip, a serial combination of two piezoelectric ceramic elements, or a parallel combination of two piezoelectric ceramic elements.

16. The laser scanning projection system as claimed in claim 9, wherein a scanning trajectory of a next image frame is shifted by a displacement from the scanning trajectory of a current image frame along a slow-axis direction

17. The laser scanning projection system as claimed in claim 16, wherein the displacement is smaller than a spacing interval between two adjacent vertical scanning lines along the slow-axis direction.

18. The laser scanning projection system as claimed in claim 9, wherein the tilt angle is smaller than 0.04 degree.

19. The laser scanning projection system as claimed in claim 9, wherein the scanning trajectory is a raster scanning trajectory or a Lissajous scanning trajectory.

20. A laser scanning projection system with reduced speckle contrast, the laser scanning projection system comprising:
a projection surface;
an illumination unit for emitting a laser beam along an optical path;
a scanning mirror module for projecting the laser beam on the projection surface according to a scanning trajectory, thereby sequentially generating a plurality of image frames at an image refresh rate; and
a driver for periodically generating a fast-axis driving signal corresponding to a fast-axis direction and a slow-axis driving signal corresponding to a slow-axis direction,
wherein the driver provides a different phase differences between the slow-axis driving signal and the fast-axis driving signal in two successive image frames.

21. The laser scanning projection system as claimed in claim 20, wherein a scanning trajectory of a next image frame is shifted by a displacement from the scanning trajectory of a current image frame along the slow-axis direction

22. The laser scanning projection system as claimed in claim 21, wherein the displacement is smaller than a spacing interval between two adjacent vertical scanning lines along the slow-axis direction.
